(19) United States
(12) Patent Application Publication
(10) Pub. No.: US 2002/0171217 A1
(43) Pub. Date: Nov. 21, 2002

(54) Steerable self-propelled all terrain vehicle

(76) Inventor: Martin Gary Sutherland, Encinitas, CA (US)

Correspondence Address: MARTIN GARY SUTHERLAND, 316 "A" ST, ENCINITAS, CA, 92024, US

(21) Appl. No.: 09/824,341

(22) Filed: Apr. 2, 2001

(51) Int. Cl. B62M 1/00

(52) U.S. Cl. 280/87.042; 280/11.222

(57) ABSTRACT

A steerable self-propelled all terrain vehicle with one large steerable wheel centered on the longitudinal axis and mounted on the front 75% of the riding board, and two or more steerable wheel that are mounted behind the large front wheel. The large steerable wheel coupled with the two or more rear steerable wheels provide improved speed and maneuverability over a wide variety of surfaces, terrain and speed ranges. The large protruding wheel's axle and related suspension provide greater controlled steerablity with improved stability while traveling over varied and rough surfaces. The steerability of the large protruding wheel and connected wheels is controlled by the movement of the operators feet, weight shift and riding board flex, also pivotal foot and ankle positioning, in other embodiments there are different ways to increase the degree of turn rate.

References cited

| | | | |
|---|---|---|---|
| 5,947,495 | Dec. 1997 | Null | 280/87. |
| 1,468,173 | Oct. 1923 | Shaw | 280/87. |
| 3,854,743 | Dec. 1974 | Hansen | 280/11 |
| 4,062,557 | Dec. 1977 | Roden | 280/87. |
| 4,337,961 | Jul. 1982 | Covert et al | 280/87 |
| 5,020,621 | Jun. 1991 | Martin | 180/87 |
| 5,022,668 | Jun. 1991 | Kenny | 280/87. |
| 5,114,166 | May. 1992 | McCosker | 280/87 |
| 5,127,672 | July. 1992 | Horibata | 280/87. |

### BACKGROUND OF THE INVENTION

1. Field of the Invention

The present invention relates to skateboard like vehicles and more particularly pretains to a improved All-Terrain vehicle that will achieve greater performance on and off-road.

2. Discription of the Prior Art

The use of skateboards is known in the prior art. More specifically, skateboards heretofore devised and utilized are known to consist basically of familiar, expected and obvious structural configurations, not withstanding the myriad of designs encompassed by the crowed prior art which have been developed for the fulfillment of countless objectives and requirements.

Known prior art skateboards include U.S. Pat. No. 3,252,713; U.S. Pat. No. 5,947,495; U.S. Pat. No. 1,975,905; U.S. Pat. No. 4,382,605; U.S. Pat. No. 5,092,614; U.S. Pat. No. 1,77,803;

These devices try to fulfill their respective, particular objectives and requirements, the aforementioned patents do not disclose a new and truly functional All-Terrain vehicle. This invention includes a elongated riding board, a front sterile wheel that protrudes through the top of the riding board and located toward the front of the board centered on the longitudinal axis of the board. Toward the rear of the board there are two or more steerable wheels centered on the longitudinal axis disposed below the deck, the axles can accept small wheels or large depending on the surface to be riden.

Prior Art in mind, the Steerable Self-Propelled three or more wheeled vehicle substantially differs from the conventional and non-conventional concepts and designs of the prior art, and provides a design primarily developed for a vehicle that can traverse any surface condition in real terms.

### SUMMARY OF THE INVENTION

In view of the foregoing disadvantages inherent in the known types of skateboards now present in the prior art, the present invention provides a new all-surface vehicle that is characterized by a single steerable wheel that protrudes up through the surface of the riding board, and two or more steerable wheels towards the rear of the riding board. The forward single wheel is positioned in the forward section of the riding board centered on the longitudinal axis. With the configuration of wheels and riding board this invention will excel in its performance over a wide range of surfaces and speed ranges. With the forward single wheel generally mounted in the front 75% of the riding board, that leaves some surface area in front of the single forward wheel for the rider to use in maneuvering, Which is accomplished by foot and weight shift. With the position of the single forward wheel at the front 75% position, not too forward and not back towards the center, the vehicle attains its unexpected results of speed, maneuverability and turning radius. Braking is accomplished by friction device.

It is the object of the present invention to provide unexpected results from the Self-Propelled All-Terrain vehicle and method which has many of the advantages of the skateboards mentioned heretofore and many novel features in performance and layout that result in the present invention, which is not anticipated, rendered obvious, suggested, or even implied by any of the prior art skateboards, either alone or in any combination thereof.

### DISCRIPTION OF THE PREFERRED EMBODIMENT

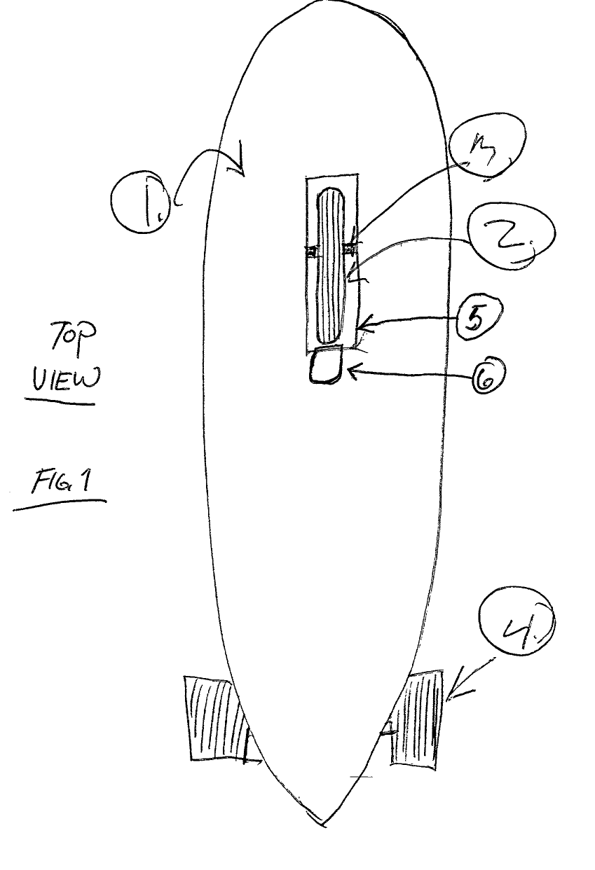

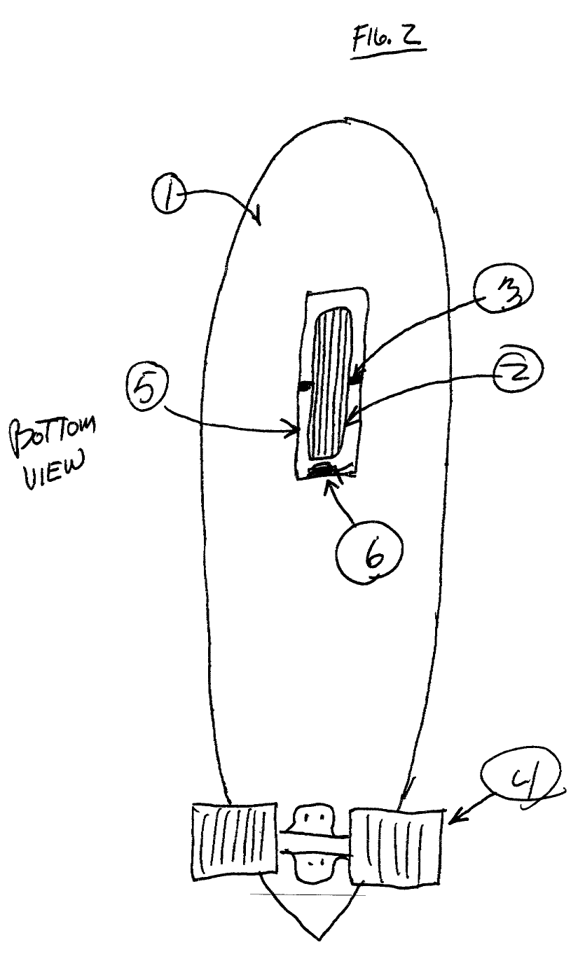

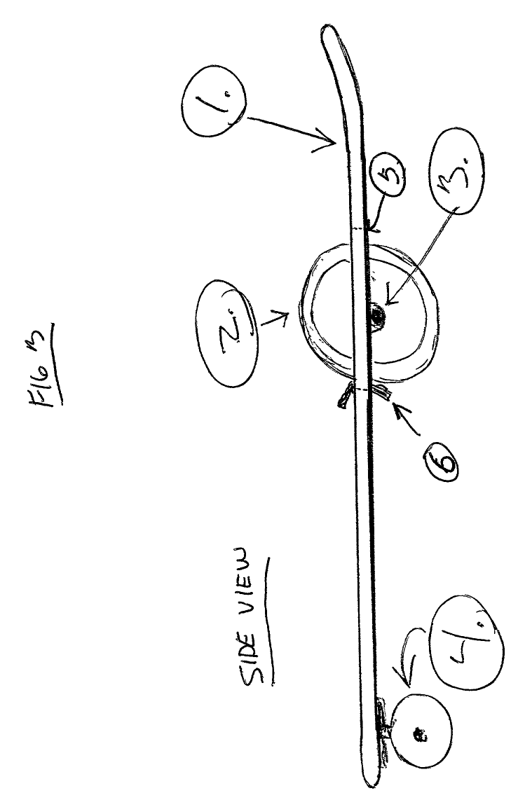

Now with reference to the drawings, and particular to FIGS. 1 through 3 thereof, a new steerable self-propelled All Terrain vehicle.

As simply illustrated in FIGS. 1 through 3. the Steerable Self-Propelled All-Terrain Vehicle comprises a elongated riding board 1. A front wheel 2. That protuds through the surface of the deck, mounted at the front 75% postion. there is a slot 5. that the front wheel protruds through. There is a axle 3 that mounts the forward wheel to the riding board. Two or more wheels 4. mounted below riding board towards rear of riding board. A spring loaded friction brake 6.

In other embodiments the platform {riding board} can flex to increase the turning radius of the All-Terrain vehicle while being riden, while turning the lateral weight shift of the rider will cause the board to flex enhancing the rate of turn, also the connective wheel suspensions and wheels can have flex that working concert with riding platform.

An additional embodiment that works with the principle of flex in the riding board and related suspensions is a foot operated turning device, when the riders foot pivots clockwise the vehicle goes right, when the riders foot pivots counter-clockwise the vehicle turns to the left. With the foot turning device the riders foot stands on the turning device platform to activate a turn. From the turning device platform that is mounted just above the riding platform surface, a shaft connected perpendicular to the turning device platform connects the turning device platform with the connection means to direct the front and rear wheels in a turning configuration, all in conjunction with the vehicles ability to flex.

### DISCRIPTION OF DRAWINGS

1. Elongated riding board.

2. Protruding forward wheel {steerable}.

3. Forward wheel axle.

4. Rear wheels {steerable}.

5. Wheel slot for front wheel.

6. Friction brake

I claim:

1. A Steeable self-propelled three or wheeled vehicle comprising of an elongated platform adapted to carry a rider, said platform having a front, center and rear.
a steerable front wheel mounted on said platform, said wheel centered on the longitudinal axis generally disposed at the front 75% position of said platform.
a steerable rear pivoting axle assembly mounted on rear portion of said platform, and including two or more laterally spaced wheels that rotate.
A single wheel rotatably mounted on a substantially fixed forward axle of said platform. The diameter and placement of the said forward single wheel makes it possible to ride solely on said forward single wheel, with said rear wheels off the riding surface.
The platform being steerable by the conventional steering method of lateral shifting of the weight of the rider while the skateboard or platform is rolling forward or rearwardly, also directional control can accomplished by pivotal foot and ankle positioning.

2. The skateboard like vehicle of claim 1 wherein said platform is generally flat viewed from the side, said vehicle can flex under lateral and vertical pressure from rider and surface the said vehicle is traveling over.

3. The skateboard like vehicle of claim 1 wherein said forward single wheel of said platform protrudes through surface of said platform centered on the longitudinal axis in the forward section of platform, {75% postion}.

4. The skateboard like vehicle of claim 1 can incorporate a brake system of a frictional type actuated by hand or foot.
